(19) United States
(12) Patent Application Publication
(10) Pub. No.: US 2023/0133844 A1
(43) Pub. Date: May 4, 2023

(54) WAVE ENERGY CONVERTER CONTROL

(71) Applicant: BOMBORA WAVE POWER EUROPE LTD, Pembroke Dock, Pembrokeshire (GB)

(72) Inventors: Marcin Aleksander GRADOWSKI, Warsaw (PL); Paul VIGARS, Frampton Cotterell (GB); Campbell Robert ALGIE, French Pass (NZ)

(73) Assignee: BOMBORA WAVE POWER EUROPE LTD, Pembroke Dock, Pembrokeshire (GB)

(21) Appl. No.: 17/913,411

(22) PCT Filed: Mar. 19, 2021
(86) PCT No.: PCT/EP2021/057105

§ 371 Date: Sep. 21, 2022

(30) Foreign Application Priority Data
Mar. 26, 2020 (GB) 2004397.2

(51) Int. Cl. F03B 15/00; F03B 13/18

(52) U.S. Cl. CPC F03B 15/00; F03B 13/18

(57) ABSTRACT

A method of controlling energy conversion and/or applied wave loads for a membrane power conversion wave energy converter (WEC) having a longitudinal axis and at least one cell having a membrane. The method includes acquiring data and determining a value relating to a local sea state at the WEC or to a WEC state of the WEC. Depending on the value determined from the acquired data, one or both of the vertical position of the at least one WEC cell relative to a free surface at still water and/or the angle of incidence of the WEC is adjusted.

### FIELD OF THE DISCLOSURE

The present disclosure relates to a method of controlling the performance of a wave energy converter (WEC) and applied wave loads thereon and to associated control systems. In particular, the disclosure relates to vertical position and angle of incidence control methods for a pressure differential wave energy converter system comprising a turbine.

### BACKGROUND

Wave energy conversion systems for generating electrical energy from wave energy are well known. A number of different systems have been proposed including pressure differential converters.

Submerged pressure differential converters (some of which are also known as membrane power conversion devices/converters or membrane-pneumatic power conversion devices/converters) use the difference in hydrodynamic pressure at different locations below a wave (depending on the vertical height of water above the converter) to produce a pressure difference within cells connected to a closed power take-off system. The pressure difference results in flow of a low inertia, low friction energy transfer fluid (e.g. air) within the closed power take-off system which transmits energy to a turbine and electrical generator.

The amplitude of the wave-induced hydrodynamic pressure variations across the WEC cell membranes is dependent on the depth of the WEC cells below the water surface. As the depth below the water surface increases, the wave-induced orbital motion of the water and thus the hydrodynamic pressure variations diminish. As a result, the energy conversion of the WEC generally decreases with depth.

Similarly, the potentially large, non-linear wave loads applied to the WEC cells generally decrease with depth.

Bombora's mWave™ system is an example of a submerged pressure differential converter and features a series of air-filled cells mounted on the sea bed.

When mounted on a seabed e.g. mounted on a concrete platform or on raised piles, the hydrodynamic pressure variations and wave-loads experienced by the WEC cells is dependent on the depth of water above the cells as described above. Where the WEC is mounted in tidal waters or in water subject to significant weather-induced water depth fluctuations, the depth of water above the WEC cells and thus the hydrodynamic pressure variations/wave loads to which the cells are subjected can vary significantly. With this variation in the hydrodynamic pressure variations experienced by the WEC cells comes a variation in the performance (i.e. energy conversion) of the WEC.

As shown in FIG. 1 herein, a WEC having a linear (longitudinal) axis is said to have a “heading” h where the heading is the direction in which the longitudinal axis is oriented towards the incident waves. The angle of incidence α is the internal angle between the direction from which the waves arrive and the heading h and this angle affects the wave loads applied to the WEC by determining the wavelength ratio and the exposed width W of the WEC. The wavelength ratio (L′/λ) is the length L′ of the WEC in a direction aligned with the direction from which the waves arrive divided by the wavelength λ of the wave. The exposed width W is the extent of the WEC in a direction perpendicular to the wave propagation direction.

As the wavelength ratio is increased (by reducing the angle of incidence), WEC efficiency is increased. However, increasing the wavelength ratio has the effect of decreasing the exposed width and this reduces the incident wave energy available for conversion. Accordingly, the heading/angle of incidence has to be selected to optimise the competing requirements to balance the WEC efficiency with incident wave energy exposure.

WECs that are mounted on the sea bed have a fixed orientation/heading relative to the prevailing wave direction and thus optimisation of the heading for changing local conditions is not possible.

WECs that are mounted on or tethered to the seabed in shallow waters (e.g. at less than 20 m depths) tend to be susceptible to biofouling as a result of the easy light penetration of the water.

There is a desire to provide a method of controlling the performance of WECs and the wave loads applied to WECs. There is also a desire to provide a way of reducing biofouling on a WEC.

### SUMMARY

In a first aspect, there is provided a method of controlling energy conversion and/or applied wave loads for a membrane power conversion wave energy converter (WEC) having a longitudinal axis and at least one cell having a membrane, said method comprising:
acquiring data and determining a value relating to a local sea state at the WEC and/or to a WEC state value; and
depending on the value determined from the acquired data, adjusting one or both of the vertical position of the at least one WEC cell relative to a free surface at still water and/or the angle between the longitudinal axis of the WEC and an incident wave direction.

The present inventors have found that adjusting the vertical position (e.g. submergence) of the cell(s) of the WEC based on the local sea state (i.e. on the current or predicted local sea state) and/or on the WEC state can optimise the balance between the WEC efficiency and protection from excessive wave loads i.e. the WEC efficiency can be maximised within the wave load limits. Similarly, adjusting the angle of incidence of the WEC converter based on the current or predicted local sea state can optimise the balance between the WEC efficiency and incident wave energy exposure.

Optional features will now be set out. These are applicable singly or in any combination with any aspect.

Where the WEC is a linear WEC or comprises at least one linear portion, the longitudinal axis of the WEC is substantially aligned with the linear extension (length dimension) of the linear WEC or with the linear extension (length dimension) of at least one of the linear portion(s). Where there are multiple linear portions, the longitudinal axis may comprise the axis of the longest linear portion.

Where the WEC is a curved WEC, the longitudinal axis may transect the arc formed by the WEC. For example, the longitudinal axis may extend along a radius of the arc to transect the arc. The longitudinal axis may transect the arc into two substantially equal portions (each subtending a substantially equal angle). For example, where the WEC forms a semi-circular arc, the longitudinal axis may extend along the radius of semi-circle and transect the arc formed by the WEC to divide the WEC into two portions each subtending a substantially equal angle (e.g. an angle of around 90 degrees).

The vertical position is the time-averaged vertical position e.g. the time-averaged submergence depth of the WEC cell below the mean free surface at still water or the time-averaged emergence height of the WEC above the mean free surface at still water.

In preferred embodiments, adjusting the vertical position (e.g. submergence/emergence) of the cell comprises raising or lowering the whole cell towards or away from the sea bed. For example, adjusting the vertical position of the cell may comprise raising or lowering the cell towards or away from the sea bed without substantially altering the inclination of the membrane relative to the horizontal direction.

Where the WEC comprises a plurality of cells e.g. a plurality of cells adjacent one another in a direction parallel to the longitudinal axis, the method may comprise adjusting the vertical position (e.g. maintaining a preferred submergence/emergence depth) for the plurality of cells. The method may comprise simultaneously adjusting/maintaining the vertical position (submergence/emergence) for the plurality of cells. For example, adjusting the submergence/emergence of the plurality cells may comprise simultaneously raising or lowering the plurality of cells towards or away from the sea bed without substantially altering the inclination of the membranes relative to the horizontal direction.

For the avoidance of doubt, it will be appreciated that whilst the longitudinal axis may be a horizontal axis, the longitudinal axis may also be inclined from the horizontal so that adjusting the vertical position (and/or angle of incidence) of a pitched WEC (where one longitudinal end portion of the WEC is vertically higher or lower than the other longitudinal end portion of the WEC) is also included within the scope of this disclosure.

Furthermore, the WEC may be rolled i.e. a transverse axis extending perpendicular to the longitudinal axis of the WEC may be inclined from the horizontal so that one lateral portion/side/edge of the WEC is vertically higher than the opposing lateral portion/side/edge. For pitched and/or rolled WECs the vertical position is the mean vertical position of the pitched/rolled WEC.

Adjustment of the vertical position and/or angle of incidence is preferably without adjustment of the pitch and/or roll of the WEC.

References to “the WEC” may refer only to the cell(s) of the WEC or may optionally include the power take-off system (e.g. the turbine).

The WEC may be a fully submerged WEC or may be a semi-submerged WEC (with at least part of the WEC (e.g. the power take-off system or a portion of the/each cell membrane) at least partially above the mean surface at still water after installation).

In order to determine the local sea state value at the WEC and/or WEC state value, the method may comprise acquiring data relating to one or more of: tidal conditions; weather conditions; wave height; wave period; wave direction; wave energy; sea current strength/direction; wave loads on the WEC; WEC depth, fluid pressure/volume/flow rate within a WEC, WEC valve positions and loads, WEC membrane position, loads and shape, turbine/generator speed/torque and energy conversion of the WEC.

In some embodiments, the method comprises acquiring data from at least one sensor mounted on or in the vicinity of the WEC. In these embodiments, it may be possible to determine the local sea state value directly from the acquired data.

Alternatively (or additionally), the method may comprise acquiring data from at least one sensor provided at a location remote from the WEC and/or from internet weather forecast data. In these embodiments, it may be necessary to apply a transfer function to the data acquired at the remote location/internet data to determine the local sea state value. The transfer function will compensate at least for the distance between the remote sensor(s) and the WEC.

The method may comprise identifying an optimal value or optimal range for the vertical position (submergence/emergence) and/or an optimal value or optimal range for the angle of incidence for the determined local sea state value e.g. using a data set such as a lookup table. The data set could initially be generated using a numerical model of WEC performance which may be calibrated against physical testing. In these embodiments, the method comprises determining the current vertical position of the WEC and/or current angle of incidence and if it/they deviate(s) from the optimal value(s)/range(s), the method comprises adjusting one or both of the vertical position and/or the angle of incidence to match the optimal value(s) or to be within the optimal range(s).

In some embodiments, the method further comprises over-writing the optimal value or optimal ranges for the vertical position (submergence/emergence) and/or angle of incidence with a revised optimal value or revised optimal range based on measured loads and/or WEC energy conversion. For example, if measured loads exceed a threshold load value, the optimal submergence/emergence or the lower limit (smallest submergence) of the optimal range can be increased (WEC lowered to towards sea bed) and/or the optimal angle of incidence or the upper limit of the angle of incidence can be decreased (WEC axis moved towards direction the waves are coming from) to reduce loads to within acceptable limits. The revised optimal values/ranges will overwrite the existing values/ranges.

Similarly, if the measured WEC performance (energy conversion) is below a threshold performance value, the optimal vertical position (submergence/emergence) or the upper limit (greatest depth) of the optimal range can be reduced (WEC raised away from the sea bed) and/or the optimal angle of incidence or the lower limit of the optimal angle of incidence range (smallest angle) can be adjusted to increase power conversion (within wave load tolerances). The revised optimal values/ranges will overwrite the existing values/ranges.

In this way, the data set of optimal values/ranges can be updated over time based on observed operating conditions.

In some embodiments where the method comprises acquiring data to determine a WEC state value, the method may comprise acquiring data (e.g. from at least one sensor mounted on the cell/WEC) relating to one or more of: cell volume; membrane loads, structural loads, cell fluid pressure, WEC valve positions, cell membrane position and shape, turbine/generator speed/torque.

The acquired data may be used to determine a power conversion WEC state value and/or a load WEC state value.

The method may comprise determining if the WEC state value has an optimum WEC state value (e.g. an optimum power conversion WEC state value and an optimum load WEC state value) or is within an optimal (e.g. power conversion and load) WEC state value range and, if the WEC state value deviates from the optimal (e.g. power conversion and load) WEC state value or is outside the optimal (e.g. power conversion and load) WEC state value range, adjusting one or both of the vertical position (submergence/emergence) and the angle of incidence.

For example, if the acquired data determines a power conversion WEC state value that is below the optimal power conversion WEC state value and the optimal power conversion WEC state value range, the vertical position (submergence/emergence) can be reduced to increase power conversion and/or the angle of incidence can be adjusted to optimise power conversion within wave load tolerances.

Similarly, if the acquired data determines a load WEC state value that is above the optimal load WEC state value or the optimal load WEC state value range, the submergence can be increased and/or the angle of incidence can be reduced to reduce excessive loads.

In some embodiments, the submergence and/or angle of incidence is adjusted until the WEC state value (e.g. the power conversion and/or load WEC state value) matches the optimal (e.g. power conversion/load) WEC state value or is within the optimal (e.g. power conversion/load) WEC state value range. This can be ascertained by acquiring further data after adjusting the submergence/angle of incidence, determining a revised WEC state value (e.g. power conversion and/or load WEC state value) and comparing the revised (e.g. power conversion and/or load) WEC state value to the optimal (e.g. power conversion and/or load) WEC state value/range. This can be repeated until the revised (e.g. power conversion and/or load) WEC state value matches the optimal (e.g. power conversion and/or load) WEC state value or is within the optimal (e.g. power conversion and/or load) WEC state value range.

In a second aspect, there is provided a membrane power conversion wave energy converter (WEC) having a longitudinal axis and at least one cell with a membrane, further comprising an adjustment actuator for adjusting the vertical position (e.g. submergence/emergence) of the at least one WEC cell relative to a free water surface at still water and/or for adjusting the angle of incidence between the longitudinal axis of the WEC and an incident wave direction.

The adjustment actuator may be configured to raise and lower the whole cell towards and away from the sea bed. For example, the adjustment actuator may be configured to raise and lower the cell towards and away from the sea bed without substantially altering the inclination of the membrane relative to the horizontal direction.

The WEC may comprise a plurality of cells each with a respective membrane e.g. a plurality of cells adjacent one another in a direction parallel to the longitudinal axis and the adjustment actuator may be configured to adjust the vertical position (submergence/emergence (e.g. maintain a preferred submergence depth)) for the plurality of cells. The adjustment actuator may be configured to simultaneously adjust/maintain the vertical position (submergence/emergence) for the plurality of cells. For example, the adjustment actuator may be configured to simultaneously raise and lower the plurality of cells towards or away from the sea bed without substantially altering the inclination of the membranes relative to the horizontal direction.

References to “the WEC” may refer only to the cell(s) of the WEC or may optionally include a power take-off system (e.g. the turbine).

The WEC may be a fully submerged WEC or may be a semi-submerged WEC (with at least part of the WEC (e.g. the power take-off system or a portion to the/each cell membrane) at least partially above the free surface at still water after installation).

In general, a vertical stable position may be achieved when the sum of all vertical forces (i.e. in an upward or downward direction) are equal to zero. When one vertical force is a function of vertical position, you may be able to control vertical position by altering another of the vertical forces. For example, one force that is a function of position is buoyancy for a surface piercing structure. For example, one force that is not a function of vertical position is mass.

In some embodiments, the adjustment actuator comprises at least one buoyancy element having an internal chamber. The volume of water within the internal chamber(s) may be variable to effect a change in buoyancy or weight of the WEC thus effecting a change in the vertical position of the WEC.

In some embodiments, the or each adjustment actuator may comprise at least one pump and/or at least one valve for adjusting the relative volume of air and water inside the internal chamber(s) of the buoyancy element(s).

For example, in some embodiments, at least one buoyancy element has an open lower end (the lower end being the end closest to the sea bed). In these embodiments, the adjustment actuator comprises a pump and a valve mounted on the (sealed) upper end of the buoyancy element which is exposed to air. The valve can be used to bleed air from the internal chamber under hydrostatic pressure thus allowing the water level within the internal chamber to rise. This reduces the volume of air within the internal chamber thus reducing the buoyancy of the WEC and thus causing the WEC to move towards the sea bed. The pump can be used to pump air into the internal chamber of the buoyancy element thus increasing the volume of air within the chamber, and increasing the buoyance of the WEC so that it moves away from the sea bed.

In other embodiments, the/each buoyancy element comprises a sealed internal chamber with a valve mounted on the exposed, sealed upper end and a pump or valve mounted on the submerged, sealed lower end. The upper valve can be used to allow flow of air into and out of the internal chamber whilst the pump or lower valve can be used to allow flow of water into the internal chamber to effect a change in mass of the buoyancy element (and thus the WEC). As the volume of water (ballast) in the buoyancy element increases, the mass increases and the WEC moves towards the sea bed. It should eb noted that the volume of water (ballast) within the buoyancy elements may cause the height of the water within the internal chamber to rise above the mean free surface at still water.

In some embodiments, the adjustment actuator comprises at least one tether affixed to the WEC at one end and affixed to the sea bed (or a mooring/anchor) at the other end. The at least one tether may have a variable length.

In some embodiments, the tether may be elastic e.g. may be a resilient spring. In static equilibrium the downwards forces (acting towards the sea bed) of the tension within the elastic tether are equal to the buoyant force of the buoyancy element(s). To move the WEC towards the seabed, ballast (e.g. water) within the internal chamber(s) is increased (e.g. using a water pump and an air bleed valve).

In some embodiments, the tether comprises a non-buoyant tether such that the balance between the weight of the tether and the weight of the WEC (which can be varied through the variation of the amount of ballast (water) within the buoyancy element(s)) can be used to control the submergence depth of the WEC. The vertical position may be increased by removing water from the buoyancy element(s), which may expand gas stored in the buoyancy element. Optionally, gas can be introduced into the buoyancy element(s) from a gas source (e.g. a compressed gas source).

Where the tether is a non-buoyant tether, one end of the tether may be affixed to the WEC and movement of the opposing end may be immobilised on the seabed by the weight of the end of the tether on the seabed.

In some embodiments, none of the vertical forces may be a function of position, and other means may be used to control vertical position.

The tether may be associated with a winch or a hydraulic ram (e.g. affixed to the WEC/buoyancy element) in order to effect the variation in length of the tether.

In some embodiments, the at least one adjustment actuator comprises at least one rack and pinion. The pinion(s) may be mounted on the buoyancy element(s) or the WEC with the rack(s) extending vertically e.g. from the sea bed. In other embodiments, either the pinions or racks are mounted on one of the WEC or the buoyancy element(s) and the other of the pinions/racks are mounted on the other of the WEC or buoyancy element(s). This allows adjustment of the vertical position of the WEC relative to the buoyancy element(s). In these embodiments, the buoyancy element(s) may further comprise one or more tethers as described above. Thus the adjustment actuator may comprise both at least one tether (e.g. affixed to the at least one buoyancy element allowing adjustment of the vertical position of the buoyancy element and WEC relative to the seabed) and at least one rack and pinion (allowing height adjustment of the WEC relative to the buoyancy element(s)).

The adjustment actuator may be for adjusting the angle of incidence. The adjustment actuator may comprise a winch controlling the length of a tether connecting the WEC to a mooring. The winch may be provided on the WEC e.g. on an end portion of the WEC such as on a corner of an end portion of the WEC. The mooring may be positioned such that the angle of incidence of the WEC is adjusted upon a change in the length of the tether by the winch. As the length of the tether is adjusted, the WEC will rotate about a pivot affixed (directly or indirectly) to the sea bed.

The adjustment actuator may comprise a plurality of moorings, winches and tethers for adjustment of angle of incidence.

In a third aspect, there is provided a WEC system comprising a WEC as described for the second aspect and a control system for controlling energy conversion and/or applied wave loads, said control system comprising:
a data source for acquiring data; and
a controller for using the acquired data to determine a value relating to a local sea state at the WEC or to a WEC state of the WEC;
wherein the controller is configured to send a signal to the adjustment actuator to adjust one or both of the vertical position and/or the angle of incidence of the WEC depending on the value determined from the acquired data.

The data source may be at least one sensor which may be configured to acquire data relating to one or more of: tidal conditions; weather conditions; wave height; wave period; wave direction; wave energy; sea current strength/direction; wave loads on the WEC; WEC depth, fluid pressure/volume/flow rate within a WEC, WEC valve positions and loads, WEC membrane position, loads and shape, turbine/generator speed/torque and energy conversion of the WEC.

The at least one sensor may be mounted on or in the vicinity of the WEC. In these embodiments, the controller may determine the local sea state value directly from the acquired data.

Alternatively (or additionally), the data source may comprise at least one sensor provided at a location remote from the WEC and/or internet weather forecast data. In these embodiments, the controller may apply a transfer function to the data acquired at the remote location/internet data to determine the local sea state value. The transfer function will compensate at least for the distance between the remote sensor(s) and the WEC.

The controller may comprise a memory storing a data set (e.g. in the form of a lookup table) comprising an optimal value or optimal range for the vertical position (e.g. submergence/emergence) and/or an optimal value or optimal range for the angle of incidence for the determined local sea state value.

The control system may determine the current vertical position (submergence/emergence) and/or current angle of incidence using an Inertial Measurement Unit (IMU) to track changes in the vertical position/angle of incidence relative to the initial installed position. However, preferably, the control system may comprise at least one vertical position sensor and/or angle of incidence sensor (e.g. mounted on the WEC) for determining the current vertical position (submergence/emergence) and/or current angle of incidence.

The vertical position sensor could be an external pressure sensor or an Acoustic Doppler Current Profiler (ADCP). The angle of incidence sensor could be a fluxgate compass or an ADCP (e.g. a single ADCP sensor could act as both a vertical position and angle of incidence sensor).

Furthermore, the ACDP sensor could also act as the sensor for acquiring the sea state data.

The controller may be configured to compare the current vertical position (submergence/emergence) and/or angle of incidence with the optimal values/ranges in the memory and if it/they deviate(s) from the optimal value(s)/range(s), to send a signal to the adjustment actuator to adjust one or both of the vertical position (submergence/emergence) and/or the angle of incidence to match the optimal value(s) or to be within the optimal range(s).

In some embodiments, the controller is configured to over-write the optimal value or optimal ranges for the vertical position (e.g. submergence depth/emergence height) and/or angle of incidence with a revised optimal value or revised optimal range based on measured loads and/or WEC energy conversion. In this way (as described above for the first aspect), the data set of optimal values/ranges can be updated over time based on observed operating conditions. The control system may comprise at least one load sensor and/or power conversion sensor.

In some embodiments where controller is configured to use the data acquired at the data source to determine a WEC state value, the data source may comprise at least one sensor mounted on the cell and configured to acquire data relating to one or more of: cell volume; membrane loads, structural loads, cell fluid pressure, WEC valve positions, cell membrane position and shape, turbine/generator speed/torque.

The controller may be configured to determine a power conversion WEC state value and/or a load WEC state value.

The controller may comprise a memory storing an optimum WEC state value (e.g. an optimum power conversion WEC state value and/or an optimum load WEC state value) and/or an optimal (e.g. power conversion and/or load) WEC state value range. The controller may be configured to determine if the WEC state value matches the optimum (e.g. power conversion and/or load) WEC state value or is within the optimal (e.g. power conversion and/or load) WEC state value range and, if it deviates from the optimal value or is outside the optimal range, to send a signal to the adjustment actuator to adjust one or both of the vertical position (submergence/emergence) and/or the angle of incidence.

In some embodiments, the control system is a closed loop or feedback control system and is configured to control vertical (submergence/emergence) and/or the angle of incidence (via the adjustment actuator) until the WEC state value (e.g. the power conversion and/or load WEC state value) matches the optimal (e.g. power conversion/load) WEC state value or is within the optimal (e.g. power conversion/load) WEC state value range.

In a fourth aspect, the present invention provides a method of reducing biofouling of a membrane power conversion wave energy converter (WEC) comprising at least one cell having a membrane, by periodically exposing the at least one cell membrane to air.

The present inventors have found that by periodically exposing the at least one cell membrane to air reduces biofouling as most bio-fouling species (even those that inhabit inter-tidal zones) cannot survive prolonged exposure above water.

Where the WEC comprises a plurality of cells each with a respective membrane e.g. a plurality of cells adjacent one another in a direction parallel to a longitudinal axis, the method may comprise exposing the plurality of cell membranes. The method may comprise simultaneously exposing the plurality of cell membranes.

The WEC may be a fully submerged WEC or may be a semi-submerged WEC (with at least part of the WEC (e.g. the power take-off system) at least partially above the free surface at still water after installation).

In some embodiments, the method comprises periodically exposing the at least one cell membrane to air for a predetermined period of time which may be at least 6 hours, e.g. at least 10 hours or 12 hours, such as at least 15 or 20 or 24 hours.

In some embodiments, the method may comprise exposing the cell membrane to air at least every three months, e.g. every two months or every month.

In some embodiments, the method comprises exposing the cell membrane for at least 6 hours at least every month.

In other embodiments, the method comprises exposing the cell membrane for at least 24 hours at least every 3 months.

In some embodiments, the method comprises acquiring data and determining a value relating to a (current or predicted) local condition at the WEC and depending on the local condition value, exposing the at least one cell membrane to air.

In some embodiments, the method comprises comparing the local condition value with a threshold condition value and, where the local condition value is below the threshold local condition value, sending a signal to the adjustment actuator to effect cell exposure.

If the local condition values are above the threshold condition values, the vertical position (submergence depth) is maintained and the data acquisition, local condition value determination and comparison with the threshold local condition value steps are repeated after a predetermined delay until the local condition value is below the threshold local condition value.

In some embodiments, the acquired data may be data related to wave conditions (e.g. wave height and/or wave loads) and, where the local wave condition value has a value below the threshold wave condition value indicating calm wave conditions (e.g. a threshold (maximum) wave height and/or threshold (maximum) wave load), the cell exposure may be effected. This will help prevent exposure of the cell membranes during wave conditions presenting damaging wave loads.

In some embodiments, the acquired data may be data related to weather conditions and, where the local weather condition value has a value below the threshold weather condition value indicating a maximum cloud cover level, the cell exposure may be effected. This will ensure exposure of the cell membranes during minimal cloud cover i.e. during sunnier conditions which accelerates destruction of biofouling species.

In some embodiments, the method comprises acquiring data from at least one sensor mounted on or in the vicinity of the WEC. In these embodiments, it may be possible to determine the local (wave and/or weather) condition value(s) directly from the acquired data.

Alternatively (or additionally), the method may comprise acquiring data from at least one sensor provided at a location remote from the WEC and/or from internet weather forecast data. In these embodiments, it may be necessary to apply a transfer function to the data acquired at the remote location/internet data to determine the local (wave and/or weather) condition value(s). The transfer function will compensate at least for the distance between the remote sensor(s) and the WEC.

In a fifth aspect, there is provided a membrane power conversion wave energy converter (WEC) having at least one cell with a membrane, further comprising an adjustment actuator for periodically exposing the at least one cell membrane to air.

The adjustment actuator may be as described above for the second aspect.

The adjustment actuator may be configured to raise the whole cell away from the sea bed to expose the cell membrane. For example, the adjustment actuator may be configured to raise the cell away from the sea bed without substantially altering the inclination of the membrane relative to the horizontal direction.

The WEC may comprise a plurality of cells each with a respective membrane e.g. a plurality of cells adjacent one another in a direction parallel to the longitudinal axis and the adjustment actuator may be configured to raise the plurality of cells. The adjustment actuator may be configured to simultaneously raise the plurality of cells to simultaneously expose the plurality of cell membranes. For example, the adjustment actuator may be configured to simultaneously raise the plurality of cells away from the sea bed without substantially altering the inclination of the membranes relative to the horizontal direction.

In a sixth aspect, there is provided a WEC system comprising a WEC as described for the fifth aspect and a control system for controlling biofouling reduction, said control system comprising:
a data source for acquiring data; and
a controller for using the acquired data to determine a value relating to a local condition at the WEC;
wherein the controller is configured to send a signal to the adjustment actuator to expose the cell membrane depending on the value determined from the acquired data.

The data source may be at least one sensor which may be configured to acquire data relating to one or more of wave conditions (e.g. wave height, wave loads) and/or weather conditions. The controller may be configured to determine a local wave condition value and/or a local weather condition value.

The at least one sensor may be mounted on or in the vicinity of the WEC. In these embodiments, the controller may determine the local (e.g. wave and/or weather) condition value(s) directly from the acquired data.

Alternatively (or additionally), the data source may comprise at least one sensor provided at a location remote from the WEC and/or internet weather forecast data. In these embodiments, the controller may apply a transfer function to the data acquired at the remote location/internet data to determine the local (e.g. wave and/or weather) condition value(s). The transfer function will compensate at least for the distance between the remote sensor(s) and the WEC.

The controller may comprise a memory storing a threshold local (e.g. wave and/or weather) condition value.

The controller may be configured to compare the local condition value with the threshold condition value and, where the local condition value has a value below the threshold local condition value, to send a signal to the adjustment actuator to effect cell exposure.

The threshold wave condition value may be a value indicating calm wave conditions (e.g. a maximum wave height and/or maximum wave load). The controller may be configured to compare the local wave condition value with the threshold wave condition value and, where the local wave condition value has a value below the threshold wave condition value, to send a signal to the adjustment actuator to effect cell exposure.

The threshold weather condition value may be a value indicating a maximum cloud cover level. The controller may be configured to compare the local weather condition value with the threshold weather condition value and, where the local weather condition value has a value below the threshold weather condition value, to send a signal to the adjustment actuator to effect cell exposure.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 shows an aerial view of a WEC;

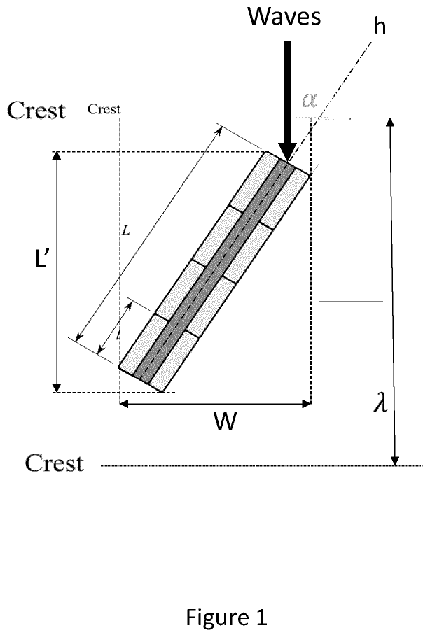

FIG. 2 shows an open loop example of a method/system;

FIG. 3 shows a closed loop example of a method/system;

FIG. 4 shows an example for reducing biofouling;

FIGS. 5a and 5b show a first example of an adjustment actuator;

FIGS. 6a and 6b show a second example of an adjustment actuator;

FIGS. 7a and 7b show a third example of an adjustment actuator;

FIGS. 8a and 8b show a fourth example of an adjustment actuator;

FIGS. 9a and 9b show a fifth example of an adjustment actuator;

FIGS. 10a and 10b show a sixth example of an adjustment actuator; and

FIG. 11 shows an example of an adjustment actuator for varying the angle of incidence.

### DETAILED DESCRIPTION AND FURTHER OPTIONAL FEATURES

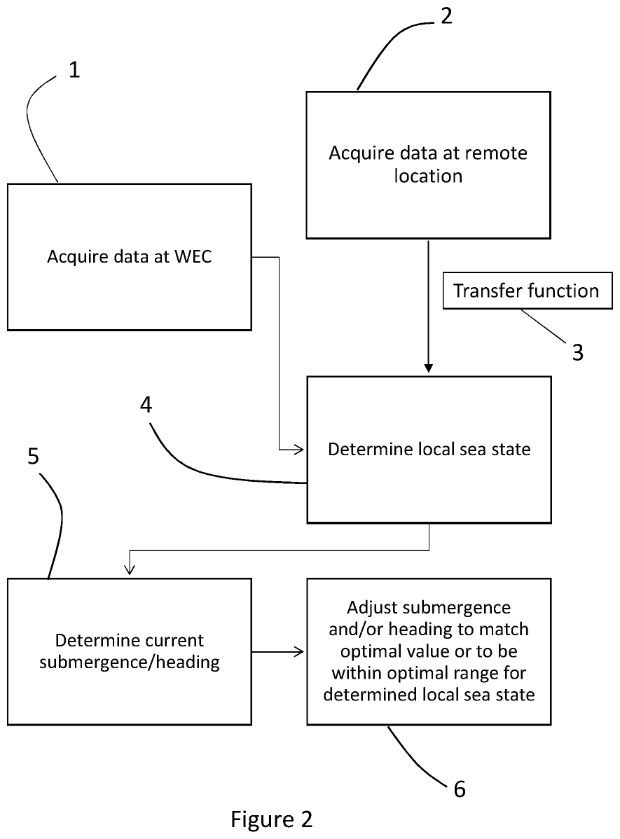

FIG. 2 shows an open loop example for controlling energy conversion and/or applied wave loads for a fully submerged membrane power conversion wave energy converter (WEC) having a longitudinal axis and a plurality of cells each having a respective membrane. The WEC is associated with a control system having a controller.

In a first step, the method comprises acquiring 1 data relating to wave loads at a sensor mounted on the WEC. In this embodiment, a further step involves acquiring 2 tidal data from an internet source at a remote location.

The controller of the control system may apply a transfer function 3 to the internet tidal data to determine the current tidal height at the WEC. The controller then uses the wave load data and the current wave height data to determine 4 a local sea state value at the WEC.

The controller comprises a memory containing a data set (lookup table) comprising an optimal range for the submergence depth and an optimal range for the angle of incidence (i.e. for the angle of incidence between the incident wave direction and the longitudinal axis of the WEC) for the each determined local sea state value.

The method comprises determining 5 the current submergence and current angle of incidence (e.g. using depth/angle of incidence sensors or from historical data stored in the memory) and if they are not within the optimal ranges, the method comprises adjusting 6 the submergence and the angle of incidence to be within the optimal ranges using an adjustment actuator associated with the WEC.

Although not shown in FIG. 2, the method further comprises over-writing the optimal ranges (e.g. overwriting the upper and/or lower limits of the ranges) for the submergence depth and/or angle of incidence with a revised optimal range based on measured loads and WEC energy conversion.

For example, if measured loads (measured using the wave load sensor) exceed a threshold load value, the lower limit (smallest depth) of the optimal submergence range can be increased (i.e. the WEC lowered to towards sea bed) to reduce loads to within acceptable limits. In this way, the data set of optimal ranges can be updated over time based on observed operating conditions.

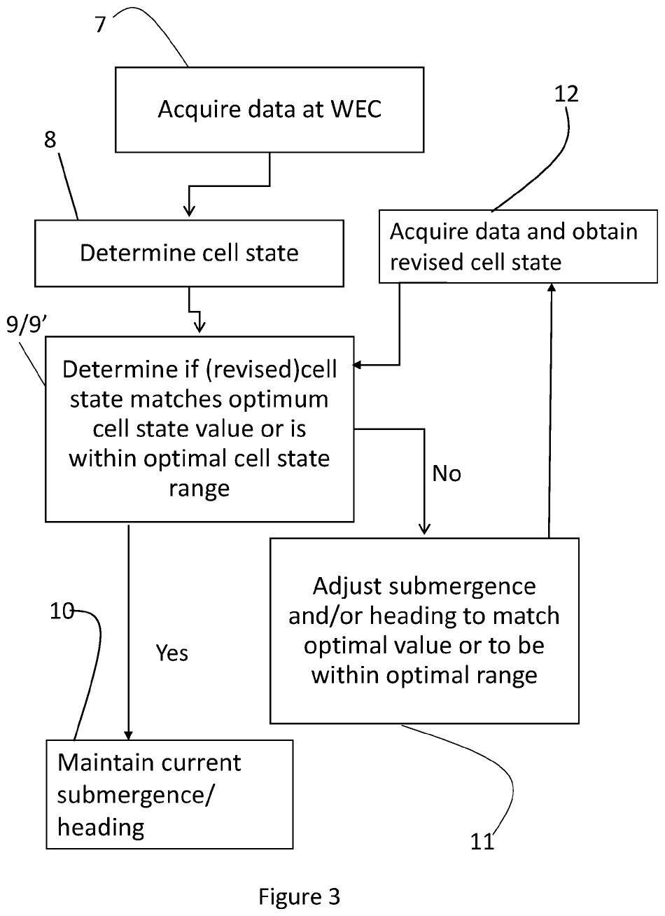

FIG. 3 shows a closed loop example for controlling energy conversion and/or applied wave loads for a partially submerged membrane power conversion wave energy converter (WEC) having a longitudinal axis and a plurality of cells each having a respective membrane. The power off-take system of the WEC is exposed. The WEC is associated with a control system having a controller.

The method comprises acquiring 7 data relating to membrane loads using a membrane-mounted sensor, and using the control system controller to determine 8 a power conversion WEC state value.

The method comprises determining 9 if the power conversion WEC state value is within an optimal power conversion WEC state value range. If the value is within the desired range, the depth and angle of incidence of the WEC is maintained 10. However, if the power conversion WEC state is outside the optimal WEC state value range, the method comprises adjusting 11 one or both of the submergence and the angle of incidence using an adjustment actuator associated with the WEC.

The submergence and/or angle of incidence is adjusted until the power conversion WEC state value is within the optimal power conversion WEC state value range. This can be ascertained by acquiring 12 further data after adjusting the submergence/angle of incidence to determine a revised power conversion WEC state value and determining 9′ if the revised power conversion WEC state value is within the desired power conversion WEC state value range. This is repeated until the revised power conversion WEC state value is within the optimal power conversion WEC state value range.

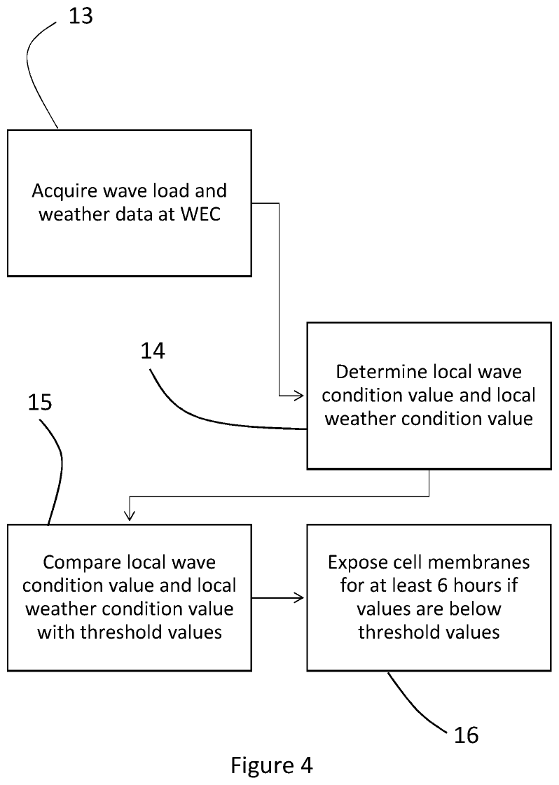

FIG. 4 shows a method of reducing biofouling of a membrane power conversion wave energy converter (WEC) comprising a plurality of cells each having a respective membrane.

The method comprises acquiring 13 data relating to wave loads using a sensor mounted on the WEC and acquiring data about local weather conditions. This data is used to determine 14 a local wave condition value and a local weather condition value.

The local wave condition and local weather condition values are compared 15 to a threshold (maximum wave load) wave condition value and a threshold (maximum cloud cover) weather condition value and where both of the values are below the threshold values, an adjustment actuator is used to raise 16 the WEC such that the cell membranes are exposed for a predetermined time period greater than 6 hours.

If the local wave condition and local weather condition values are above the threshold values, the submergence depth is maintained and the method is repeated after a predetermined delay until at least the local wave condition value is below the threshold wave condition value.

The exposure method is repeated at monthly intervals. Every third month, the predetermined time period is increased to 24 hours.

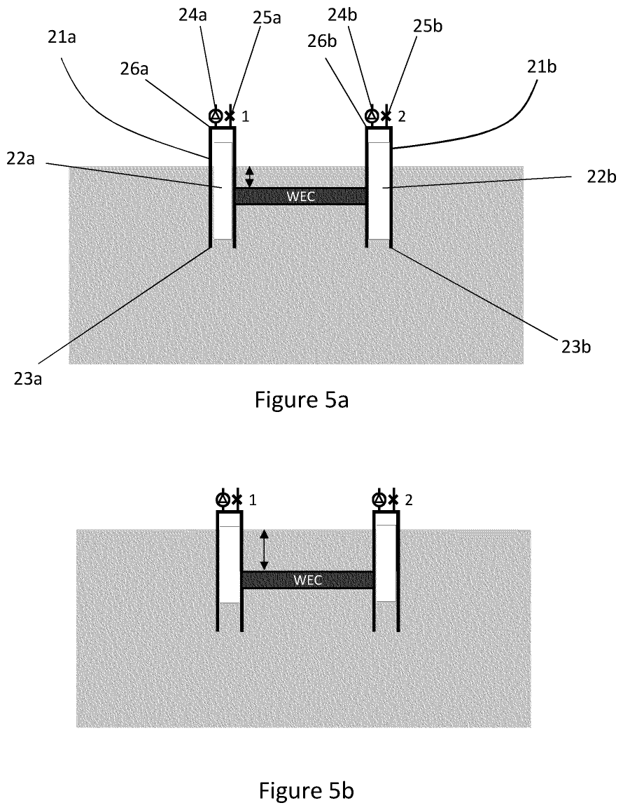

FIG. 5 onwards show examples of adjustment actuators that can be used in the exemplified methods shown in FIGS. 2-4.

FIG. 5a shows a first example of an adjustment actuator on a WEC 20. The adjustment actuator comprises opposing one buoyancy elements 21a, 21b each having an internal chamber 22a, 22b.

Each buoyancy element 21a, 21b has an open lower end 23a, 23b (the lower end being the end closest to the sea bed) and the adjustment actuator comprises a pump 24a, 24b and a valve 25a, 25b mounted on the (sealed) upper ends 26a, 26b of the buoyancy elements 21a, 21b which are exposed to air.

The valves 25a, 25b are used to bleed air from the internal chambers 22a, 22b under hydrostatic pressure thus allowing the water level within the internal chambers 22a, 22b to rise (as shown in FIG. 5b). This reduces the volume of air within the internal chambers 22a, 22b thus reducing the buoyancy of the WEC and thus causing the WEC to move towards the sea bed. The pumps 24a, 24b can be used to pump air into the internal chambers 22a, 22b of the buoyancy elements 21a, 21b thus increasing the volume of air within the chambers 22a, 22b, and increasing the buoyance of the WEC so that it moves away from the sea bed (as shown in FIG. 5a).

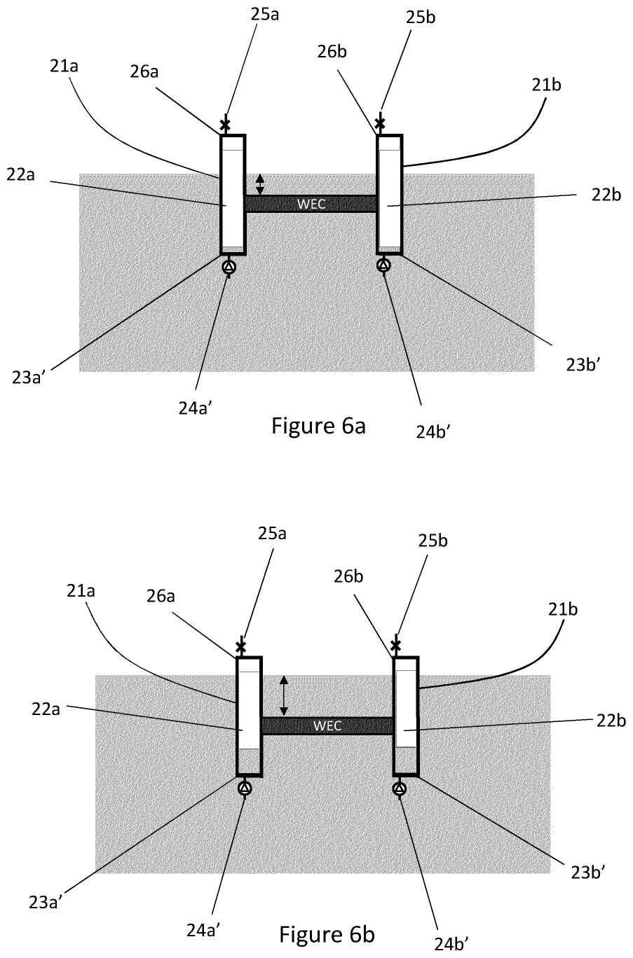

The example shown in FIGS. 6a and 6b is similar to that shown in FIGS. 5a and 5b except that the lower ends 23a′, 23b′ of the buoyancy elements 21a, 21b are sealed and the pumps 24a′, 24b′ are mounted on the sealed lower ends 23a′, 23b′.

The valves 25a, 25b can be used to allow flow of air into and out of the internal chamber 22a, 22b whilst the pumps 24a′, 24b′ can be used to allow flow of water into the internal chambers 22a, 22b to effect a change in mass of the buoyancy elements 21a, 21b (and thus the WEC). As the volume of water (ballast) in the buoyancy elements 21a, 21b increases, the mass increases and the WEC moves towards the sea bed (as shown in FIG. 6b). It should be noted that the height of the water (ballast) within the internal chambers 22a, 22b of the buoyancy elements 21a, 21b may be raised above the mean free surface at still water.

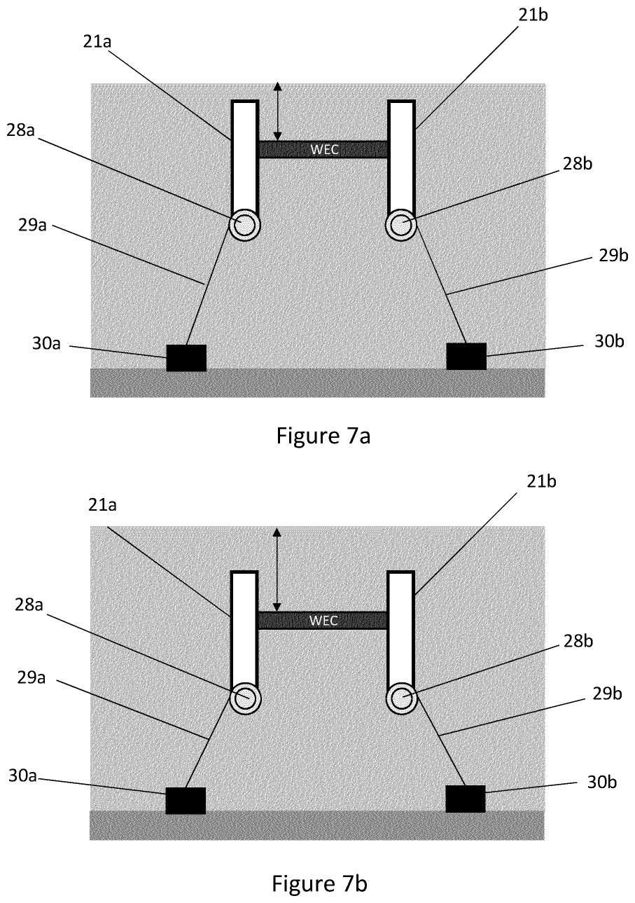

A third example of an adjustment actuator is shown in FIGS. 7a and 7b. The buoyancy elements 21a, 21b are sealed and filled with air. Each buoyancy element comprises a winch 28a, 28b around which a tether 29a, 29b is wound. Opposing ends of the tethers 29a, 29b are affixed to a moorings 30a, 30b. The tethers 29a, 29b can be lengthened (FIG. 7a) or shortened (FIG. 7b) suing the winch to adjust the vertical position of the WEC.

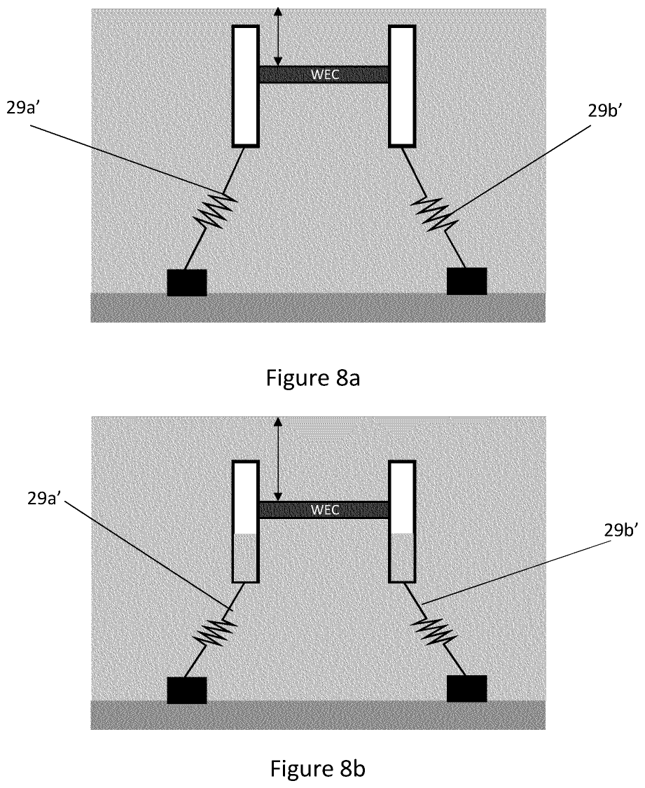

In a fourth example shown in FIGS. 8a and 8b, the tethers 29a′ and 29b′ are formed of resilient springs. In static equilibrium the downwards forces (acting towards the sea bed) of the tension within the elastic tethers 29a′, 29b′ are equal to the buoyant force of the buoyancy elements 21a, 21b (as shown in FIG. 8a). To move the WEC towards the seabed, ballast (water) within the internal chambers 22a, 22b is increased (e.g. using a water pump and an air bleed valve—not shown) as shown in FIG. 8b.

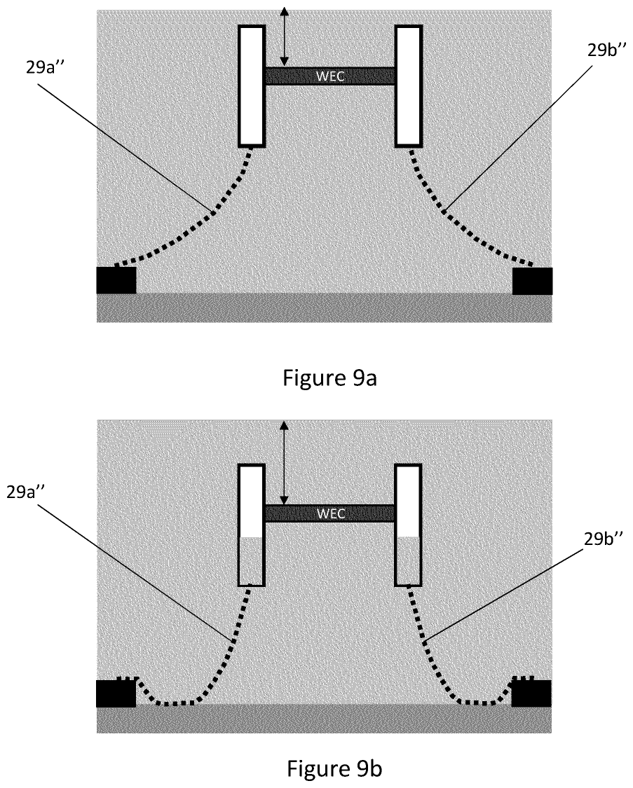

In a fifth example shown in FIGS. 9a and 9b, the tethers 29a″, 29b″ comprise a non-buoyant tether which may be a chain. The balance between the weight of the tethers 29a″, 29b″ (which will be less when the chain is supported on the sea bed-see FIG. 9b) and the weight of the WEC (which can be varied through the variation of the amount of ballast (water) within the buoyancy elements 21a, 21b) can be used to control the submergence depth of the WEC.

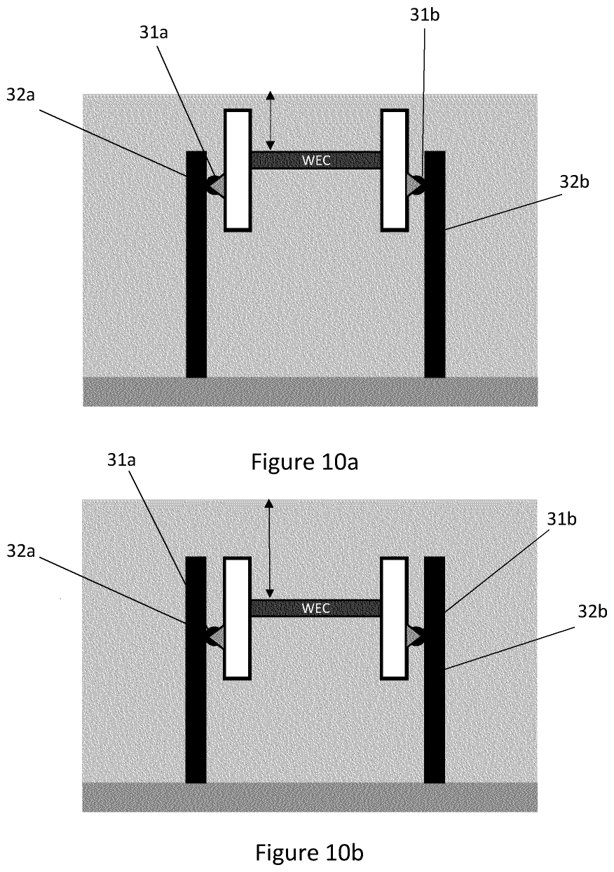

In a final example shown in FIGS. 10a, 10b, the adjustment actuator comprises opposing pinon gears 31a, 31b which cooperate with respective racks 32a, 32b extending vertically from the sea bed.

The adjustment actuator is configured to simultaneously raise and lower the plurality of cells towards or away from the sea bed without substantially altering the inclination of the membranes relative to the horizontal direction.

It should be noted that the tether embodiments shown in FIGS. 7a, 7b, 8a, 8b, 9a and 9b may be combined with the pinion/rack embodiment shown in FIGS. 10a-10b to provide a WEC with pinion gears which cooperate with respective racks on the tethered buoyancy elements.

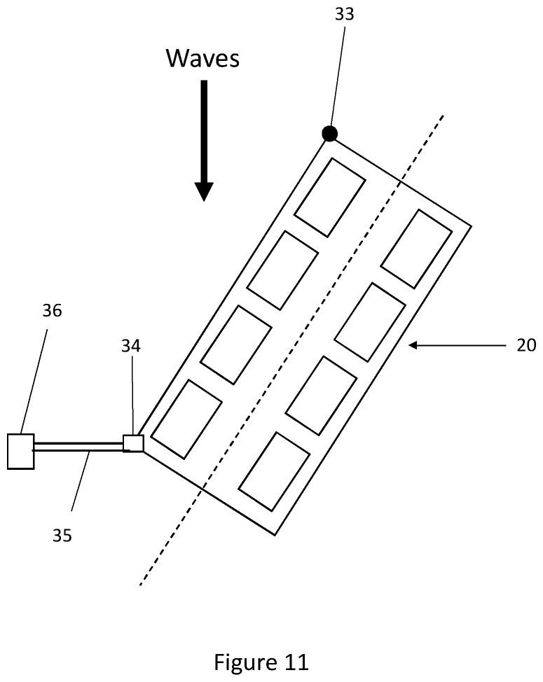

FIG. 11 shows an adjustment actuator to adjusting the angle of incidence of the WEC 20. In this embodiment, the WEC 20 is attached to the sea bed at a pivot 33. A winch 34 is affixed to a corner of a lateral end of the WEC 20. The winch 34 is attached to a tether 35 which is also attached to a fixed mooring 36. The tether 35 can be shortened by the winch to increase the angle of incidence or lengthened to decrease the angle of incidence.

In other embodiments, instead of a fixed pivot, a second winch/tether/mooring arrangement is provided at the opposing lateral end at the opposite corner and as one tether is reduced in length, the other is increased.

It will be understood that the disclosure is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of controlling energy conversion and/or applied wave loads for a membrane power conversion wave energy converter (WEC) having a longitudinal axis and at least one cell having a membrane, said method comprising:
acquiring data and determining a value relating to a local sea state at the WEC and/or to a WEC state of the WEC; and
depending on the value determined from the acquired data, adjusting one or both of the vertical position of the at least one WEC cell relative to a free surface at still water and/or the angle between the longitudinal axis of the WEC and an incident wave direction.

2. A method according to claim 1 wherein the WEC comprises a plurality of cells each with a respective membrane and wherein the method comprises adjusting the submergence of the plurality cells simultaneously without substantially altering the inclination of the membranes relative to the horizontal direction.

3. A method according to claim 1 comprising acquiring data to determine a local sea state value by acquiring data relating to one or more of: tidal conditions; weather conditions; wave height; wave period; wave direction; wave energy; sea current strength/direction; wave loads on the WEC; WEC depth, fluid pressure/volume/flow rate within a WEC, WEC valve positions and loads, WEC membrane position, loads and shape, turbine/generator speed/torque and energy conversion of the WEC.

4. A method according to claim 1 comprising identifying an optimal value or optimal range for the vertical position and/or an optimal value or optimal range for the angle of incidence for the determined local sea state value, comparing a current vertical position and/or current angle of incidence and, if it/they deviate(s) from the optimal value(s)/range(s), adjusting one or both of the vertical position and/or the angle of incidence to match the optimal value(s) or to be within the optimal range(s).

5. A method according to claim 4 comprising over-writing the optimal value or optimal ranges for the vertical position and/or angle of incidence with a revised optimal value or revised optimal range based on measured loads and/or WEC energy conversion.

6. A method according to claim 1 comprising acquiring data to determine a WEC state value by acquiring data relating to one or more of: cell volume; membrane loads, structural loads, cell fluid pressure, WEC valve positions, cell membrane position and shape, turbine/generator speed/torque.

7. A method according to claim 6 comprising determining if the WEC state value has an optimum WEC state value or is within an optimal WEC state value range and, if the WEC state value deviates from the optimal WEC state value or is outside the optimal WEC state value range, adjusting one or both of the vertical position and/or the angle of incidence,
wherein the vertical position and/or angle of incidence is adjusted until the WEC state value matches the optimal) WEC state value or is within the optimal WEC state value range.

8-34. (canceled)

35. A method of controlling energy conversion and/or applied wave loads for a membrane power conversion wave energy converter (WEC) having a longitudinal axis and at least one cell having a membrane, said method comprising:
acquiring data and determining a local sea state value relating to a local sea state at the WEC and a WEC state value relating to a WEC state of the WEC; and
depending on the values determined from the acquired data, adjusting one or both of the vertical position of the at least one WEC cell relative to a free surface at still water and/or the angle between the longitudinal axis of the WEC and an incident wave direction,
wherein the WEC state value is a power conversion WEC state value and/or a load WEC state value.

36. A method according to claim 35 wherein the WEC comprises a plurality of cells each with a respective membrane and wherein the method comprises adjusting the submergence of the plurality cells simultaneously without substantially altering the inclination of the membranes relative to the horizontal direction.

37. A method according to claim 35 comprising acquiring data to determine a local sea state value by acquiring data relating to one or more of: tidal conditions; weather conditions; wave height; wave period; wave direction; wave energy; sea current strength/direction; wave loads on the WEC; WEC depth, fluid pressure/volume/flow rate within a WEC, WEC valve positions and loads, WEC membrane position, loads and shape, turbine/generator speed/torque and energy conversion of the WEC.

38. A method according to claim 35 comprising identifying an optimal value or optimal range for the vertical position and/or an optimal value or optimal range for the angle of incidence for the determined local sea state value, comparing a current vertical position and/or current angle of incidence and, if it/they deviate(s) from the optimal value(s)/range(s), adjusting one or both of the vertical position and/or the angle of incidence to match the optimal value(s) or to be within the optimal range(s).

39. A method according to claim 38 comprising over-writing the optimal value or optimal ranges for the vertical position and/or angle of incidence with a revised optimal value or revised optimal range based on measured loads and/or WEC energy conversion.

40. A method according to claim 35 comprising acquiring data to determine a WEC state value by acquiring data relating to one or more of: cell volume; membrane loads, structural loads, cell fluid pressure, WEC valve positions, cell membrane position and shape, turbine/generator speed/torque.

41. A method according to claim 40 comprising determining if the WEC state value has an optimum WEC state value or is within an optimal WEC state value range and, if the WEC state value deviates from the optimal WEC state value or is outside the optimal WEC state value range, adjusting one or both of the vertical position and/or the angle of incidence.

42. A method according to claim 41 wherein the vertical position and/or angle of incidence is adjusted until the WEC state value matches the optimal WEC state value or is within the optimal WEC state value range.

43. A method of controlling energy conversion and/or applied wave loads for a membrane power conversion wave energy converter (WEC) having a longitudinal axis and at least one cell having a membrane, said method comprising:
acquiring data and determining a value relating to a WEC state of the WEC; and
depending on the value determined from the acquired data, adjusting one or both of the vertical position of the at least one WEC cell relative to a free surface at still water and/or the angle between the longitudinal axis of the WEC and an incident wave direction.
wherein the submergence and/or angle of incidence is adjusted until the WEC state value matches an optimal WEC state value or is within an optimal range.

44. A method according to claim 43 wherein the WEC comprises a plurality of cells each with a respective membrane and wherein the method comprises adjusting the submergence of the plurality cells simultaneously without substantially altering the inclination of the membranes relative to the horizontal direction.

45. A method according to claim 43 comprising acquiring data to determine a WEC state value by acquiring data relating to one or more of: cell volume; membrane loads, structural loads, cell fluid pressure, WEC valve positions, cell membrane position and shape, turbine/generator speed/torque.

46. A method according to claim 45 comprising determining if the WEC state value has an optimum WEC state value or is within an optimal WEC state value range and, if the WEC state value deviates from the optimal WEC state value or is outside the optimal WEC state value range, adjusting one or both of the vertical position and/or the angle of incidence.

47. A method according to claim 46 wherein the vertical position and/or angle of incidence is adjusted until the WEC state value matches the optimal) WEC state value or is within the optimal WEC state value range.
